(19) United States
(12) Patent Application Publication
(10) Pub. No.: US 2008/0197063 A1
(43) Pub. Date: Aug. 21, 2008

(54) Fluid Flow Interruption Means for Filter of Water Purifier

(75) Inventor: Min-won Kim, Chungcheongbuk-do (KR)

Correspondence Address: EGBERT LAW OFFICES, 412 MAIN STREET, 7TH FLOOR, HOUSTON, TX, 77002, US

(73) Assignee: Microfilter Co., Ltd., Chungcheongbuk-do (KR)

(21) Appl. No.: 10/579,365

(22) PCT Filed: Dec. 16, 2005
(86) PCT No.: PCT/KR05/04344

§ 371 Date: May 15, 2006

(30) Foreign Application Priority Data
Mar. 11, 2005 (KR) 10-2005-0020547

(51) Int. Cl. B01D 35/14

(52) U.S. Cl. 210/137

(57) ABSTRACT

A water purifier includes a head which is defined with a guide passage in communication with an inlet port. an outlet port, and a filter body which purifies the fluid flowing therein through the guide passage of the head and transfers purified fluid to the outlet port of the head. The filter of the present invention includes a fluid flow interrupter which is disposed in the guide passage to controllably open and close the guide passage by spring force when the head and the filter body are coupled to and de-coupled from each other. There is at least one through-hole which is defined on an upper end of the filter body so that fluid having passed through the guide passage can flow through the through-hole into the filter body.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a fluid flow interruption means which is disposed in a filter for a water purifier so as to interrupt fluid flow even without using a separate water flow interruption valve when cleaning the inside of the filter or when replacing a filtering element arranged in the filter, thereby improving an outer appearance of the water purifier and rendering user convenience.

### BACKGROUND OF THE INVENTION

In a conventional water purifier for purifying water through a physical or chemical procedure, as can be readily seen from FIG. 1, a pre-treatment filter 1, a pre-carbon filter 2, a membrane filter 3, a post-carbon filter 4, and so forth, each of which has an inlet port and an outlet port, are selectively adapted and used depending upon an intended use of the water purifier.

The inlet ports and the outlet ports of the respective filters for the water purifier are connected with one another by tubes. The inlet port of the pre-treatment filter 1 is connected to a water supply source A via a water pipe, and a fluid flow interruption valve 5 is installed on the water pipe which extends between the inlet port of the pre-treatment filter 1 and the water supply source A.

A purified water tank 6 is connected to the water pipe, which is connected to the outlet port of the post-carbon filter 4.

In the conventional filter for a water purifier constructed as mentioned above, when the filter has been used for a predetermined period, the inside of the filter must be cleaned or a filtering element arranged in the filter must be replaced with a new one.

To this end, the fluid flow interruption valve 5 is manipulated to a closed position so that fluid flow through the water pipe is interrupted. Then, the filter is dis-assembled from the water pipe and the inside of the filter is cleaned or the filtering element is substituted with a new one. Thereupon, the filter is re-assembled to the water pipe, and the fluid flow interruption valve 5 is manipulated to an open position so that fluid flow through the water pipe is allowed.

The water purifier is generally installed adjacent to a wall for ensuring efficient utilization of room space, and the fluid flow interruption valve 5 for interrupting water supply is installed on the water pipe which connects the water purifier to the water supply source A. While it is preferred that the fluid flow interruption valve 5 be installed inside a structural component (for example, a kitchen sink, storage furniture, etc.) arranged in a room so that the fluid flow interruption valve 5 is not viewed from the outside for aesthetical viewpoints, difficulties are caused when installing the fluid flow interruption valve 5 in the narrow space defined in the structural component. Also, since the fluid flow interruption valve 5 installed in the structural component must be manipulated so as to interrupt fluid flow every time the inside of a filter is cleaned or a filtering element arranged in the filter is substituted, convenience is deteriorated.

In order to cope with this problem, while it is possible to install the fluid flow interruption valve 6 adjacent to the water supply source A without considering aesthetics, when using the water supply source A (for example, to wash dishes), smooth movement of the human body may not be ensured due to the presence of the fluid flow interruption valve 5. Further, since the fluid flow interruption valve 5 must be manipulated so as to interrupt fluid flow every time, the inside of a filter is cleaned or a filtering element arranged in the filter is substituted, convenience is deteriorated.

### BRIEF SUMMARY OF THE INVENTION

Accordingly, the present invention has been made keeping in mind the above problems occurring in the prior art, and an object of the present invention is to provide fluid flow interruption means which is disposed in a filter for a water purifier so as to interrupt fluid flow even without installing a separate water flow interruption valve when cleaning the inside of the filter or replacing a filtering element arranged in the filter, thereby improving the outer appearance of the water purifier and rendering user convenience.

In order to achieve the above object, according to one aspect of the present invention, there is provided a filter for a water purifier, including a head which is defined by a guide passage for guiding fluid introduced into the head through an inlet port and has an outlet port for discharging purified fluid to the outside. A filter body is threadedly locked to the head into which the fluid flows through the guide passage communicated with the inlet port of the head, which purifies the fluid flowing therein and transfers purified fluid to the outlet port of the head. The filter comprises a fluid flow interruption means comprising an elastic spring. A fluid flow interrupter is disposed in the guide passage communicated with the inlet port and having a fluid guide rod which is formed at one end of the fluid flow interrupter and an opening and closing body which is connected at one end thereof to the fluid guide rod and has a diameter gradually decreasing in a downward direction, around which an O-ring is fitted and from the other end of which an opening and closing projection is formed. The fluid flow interrupter functions to controllably open and close the guide passage by force of the elastic spring when the head and the filter body are coupled to and un-coupled from each other. There is at least one through-hole defined on an upper end of the filter body so that fluid having passed through the guide passage communicated with the inlet port can flow through the through hole into the filter body. A hollow cylindrical protuberance, which has an inner diameter greater than an outer diameter of the fluid guide rod of the fluid flow interrupter, is formed at one end of the guide passage. The other end of the guide passage has an inner diameter gradually decreasing in the downward direction, and the elastic spring has one end through which the fluid guide rod of the fluid flow interrupter is inserted. The other end is fitted around the hollow cylindrical protuberance.

According to another aspect of the present invention, the filter further comprises a bracket having one end which is coupled to an outer surface of the head and the other end which is fastened to a wall.

### BRIEF DESCRIPTION OF THE SEVERAL VIEWS OF THE DRAWINGS

FIG. 1 is a partial elevation view illustrating a conventional connection structure between filters provided in a water purifier.

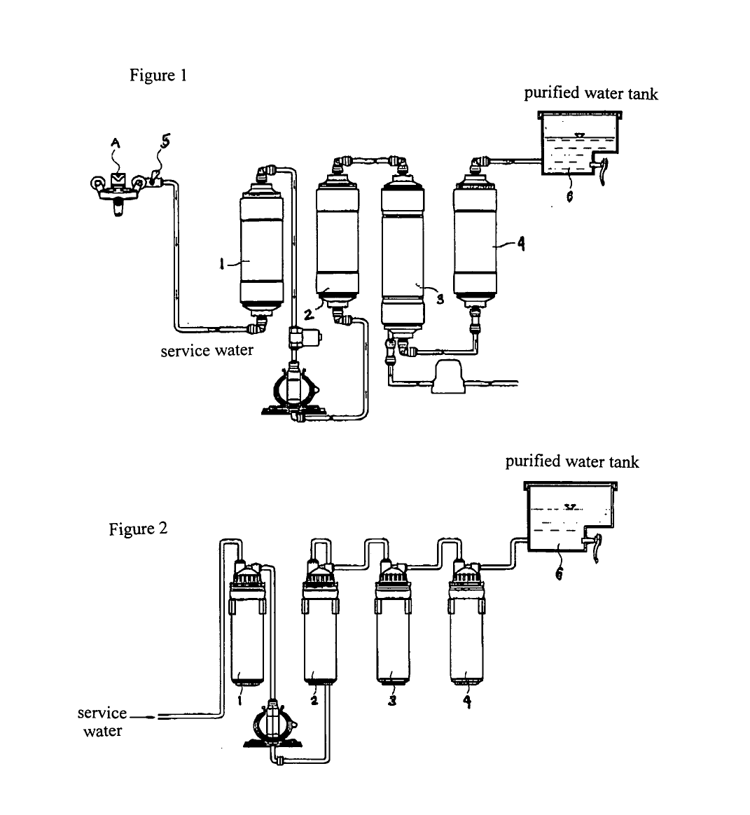

FIG. 2 is another partial elevation view illustrating a connection structure between filters provided in a water purifier in accordance with an embodiment of the present invention.

FIG. 3 is an exploded perspective view illustrating a filter for the water purifier according to the present invention.

FIG. 4 is a partially enlarged cross-sectional view illustrating the assembled state of the filter for the water purifier according to the present invention.

FIGS. 5 and 6 are cross-sectional views illustrating operational states of the filter for the water purifier according to the present invention.

### DETAILED DESCRIPTION OF THE INVENTION

Reference will now be made in greater detail to a preferred embodiment of the invention, an example of which is illustrated in the accompanying drawings. Whenever possible, the same reference numerals will be used throughout the drawings and the description to refer to the same or like part.

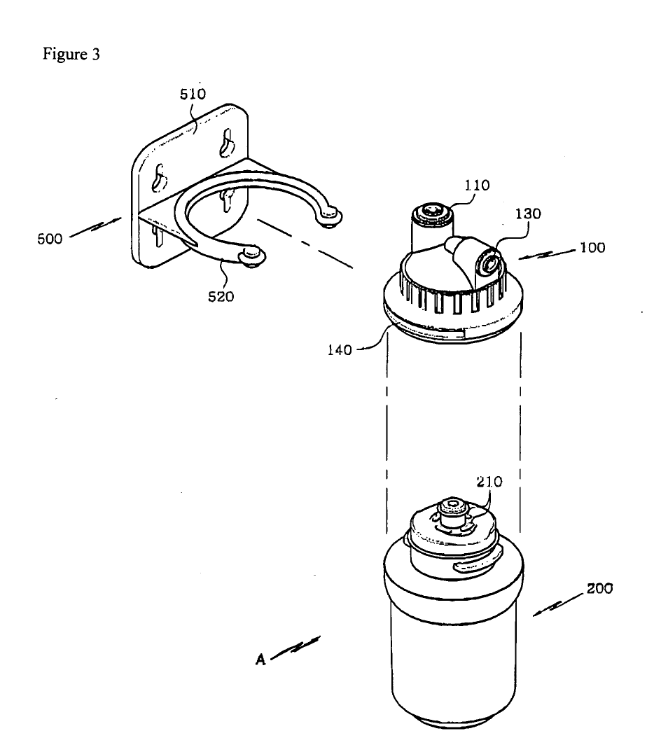

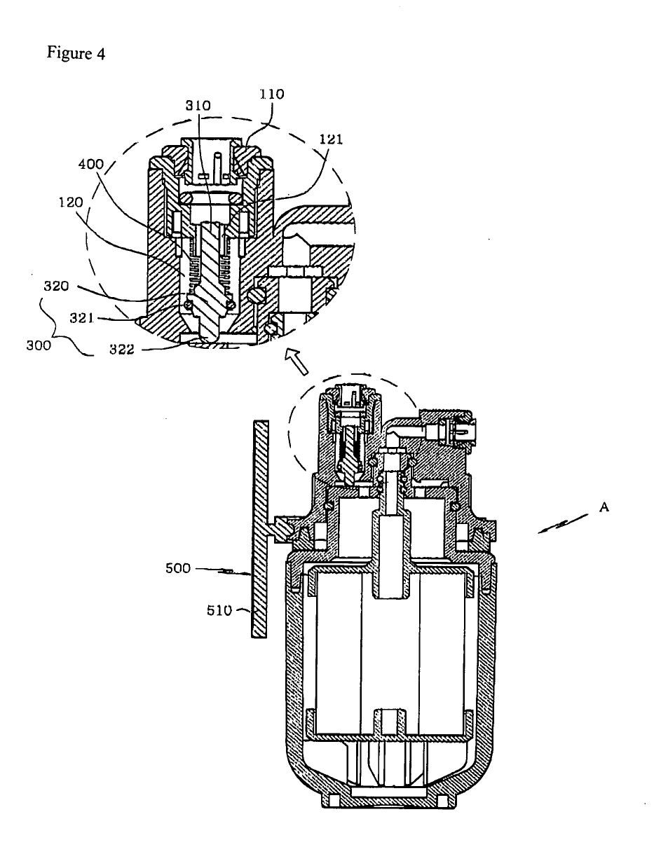

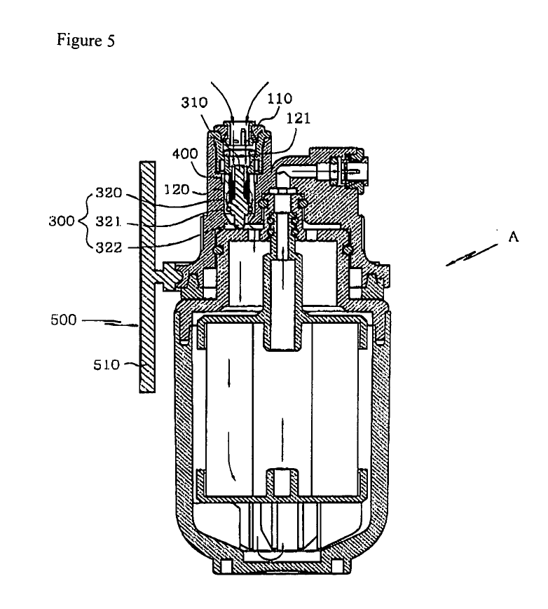

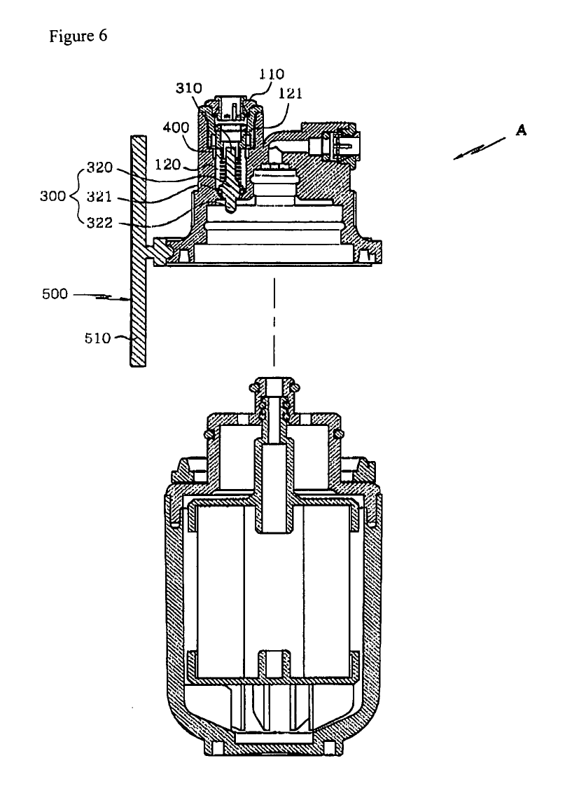

FIG. 2 is a partial main view illustrating a connection structure between filters provided in a water purifier in accordance with an embodiment of the present invention. FIG. 3 is an exploded perspective view illustrating a filter for the water purifier according to the present invention. FIG. 4 is a partially enlarged cross-sectional view illustrating the assembled state of the filter for the water purifier according to the present invention, and FIGS. 5 and 6 are cross-sectional views illustrating operational states of the filter for the water purifier according to the present invention.

As shown in the drawings, a filter A for a water purifier in accordance with an embodiment of the present invention includes a head 100 which is defined with a guide passage 120 for guiding fluid introduced into the head 100 through an inlet port 110 and has an outlet port 130 for discharging purified fluid to the outside. A filter body 200 is threadedly locked to the head 100 and into which the fluid flows through the guide passage 120 in communication with the inlet port 110 of the head 100. The filter body 200 purifies the fluid flowing therein and transfers purified fluid to the outlet port 130 of the head 100. The filter A comprises a fluid flow interruption means. In the filter A, according to the present invention, a fluid flow interrupter 300 is disposed in the guide passage 120 communicating with the inlet port 110 to controllably open and close the guide passage 120 by spring force when the head 100 and the filter body 200 are coupled to and un-coupled from each other. At least one through-hole 210 is defined through the upper end of the filter body 200 so that fluid, having passed through the guide passage 120 in communication with the inlet port 110, can flow through the throughhole 210 into the filter body 200.

The fluid flow interruption means, provided to the filter A for a water purifier, according to the present invention, includes an elastic spring 400. The fluid flow interrupter 300 is composed of a fluid guide rod 310, which is formed at one end of the fluid flow interrupter 300 and an opening and closing body 320 which is connected at one end thereof to the fluid guide rod 310. The opening and closing body 320 has a diameter gradually decreasing in a downward direction, around which an O-ring 321 is fitted and from the other end of which an opening and closing projection 322 is formed. A hollow cylindrical protuberance 121 which has an inner diameter greater than an outer diameter of the fluid guide rod 310 of the fluid flow interrupter 300 is formed at one end of the guide passage 120. The other end of the guide passage 120 has an inner diameter gradually decreasing in the downward direction. The elastic spring 400 has one end through which the fluid guide rod 310 of the fluid flow interrupter 300 is inserted and another end which is fitted around the hollow cylindrical protuberance 121.

One end of the guide passage 120 has an inner diameter which is greater than the outer diameter of the fluid guide rod 310 of the fluid flow interrupter 300 so that the fluid can flow between the guide passage 120 and the fluid guide rod 310. The other end of the guide passage 120 has the inner diameter which is gradually decreased in the downward direction. The lowermost end of the guide passage 120 has an inner diameter which is slightly greater than the outer diameter of the opening and closing projection 322 so that the opening and closing projection 322 of the opening and closing body 320 can pass through the lowermost end of the guide passage 120.

It the preferred that the through-hole 210 is defined on the upper end of the filter body 200 so as not to be arranged in line with the opening and closing projection 322 which projects from the opening and closing body 320. Due to this fact, when threadedly coupling the filter body 200 to the head 100, the opening and closing body 322 is prevented from being inserted into the through-hole 210, whereby unintentional closing of the guide passage 120 in communication with the inlet port 110 can be avoided.

Preferably, four through-holes are defined through the upper end of the filter body 200 such that they are spaced apart from one another by a predetermined angle in the circumferential direction of the filter body 200.

The fluid flow interruption means, provided to the filter A for a water purifier, according to the present invention, further includes a bracket 500. The bracket 500 is composed of a fastening plate 5 10, and a clip element 520 which is formed on a surface of the fastening plate 510 and is partially opened. The clip element 520, which is provided to the bracket 500 and is partially opened, is fitted around the outer surface of the head 100, and the fastening plate 510 is fastened to a wall member. At this time, in order to ensure that the bracket 500 is firmly coupled to the head 100, it is preferred that the outer surface of the head 100 around which the clip element 520 is fitted is defined with a fitting groove 140.

The fluid flow interruption means of the present invention can be installed in all filters provided in a water purifier, such as a pre-treatment filter 1, a pre-carbon filter 2, a membrane filter 3, a post-carbon filter 4 and so forth. Of course, it is to be readily understood that the fluid flow interruption means of the present invention can be selectively installed in one or more of the filters provided in a water purifier.

When using the filter A for a water purifier which is provided with the fluid flow interruption means, according to the present invention constructed as mentioned above, the fluid flow interrupter 300 is disposed in the guide passage 120 in communication with the inlet port 110. The fluid guide rod 310, which is formed at one end of the fluid flow interrupter 300, is inserted into the hollow cylindrical protuberance 121 which is formed at one end of the guide passage 120. At this time, the elastic spring 400 is fitted around the outer surface of the fluid guide rod 310, which is inserted into the hollow cylindrical protuberance 121, and the distal end of the opening and closing projection 322, which projects downwards from the opening and closing body 320, is exposed out of the lower end of the guide passage 120 and is supported on the upper end surface of the filter body 200.

At this time, due to the fact that the elastic spring 400 is maintained in a compressed state with the other end thereof seated on the upper end of the guide passage 120 and one end thereof seated on the opening and closing body 320, service water, which is introduced into the head 100 through the inlet port 110, flows through the space defined between the guide passage 120 and the fluid guide rod 310 which is inserted into the hollow cylindrical protuberance 121. The service water is then discharged out of the lowermost end of the guide passage 120 and the upper end surface of the filter body 200.

Thereafter, the service water is introduced into the filter body 200 through the through-holes 210, which are defined through the upper end of the filter body 200. The service water is purified and is discharged to the outside through the outlet port 130. In this way, a water purifying procedure is implemented.

This water purifying procedure using the fluid flow interrupter can be entirely or selectively adapted for the filters provided in a water purifier.

While the water purifier is used, if it is necessary to clean the inside of the filter A or substitute a filtering element arranged in the filter A, the filter body 200 of the filter A is grasped, and the filter body 200 is unthreaded from the head 100. The elastic spring 400 is maintained in a compressed state between the fluid guide rod 310 and the one end of the guide passage 120. The spring 400 is decompressed, and the opening and closing body 320 of the fluid flow interrupter 300 further projects out of the lowermost end of the guide passage 120, being engaged with the other end of the guide passage 120, which is gradually decreased in its inner diameter in the downward direction as a result of which the guide passage 120 is closed by the opening and closing body 320.

Due to the fact that the O-ring 321 is fitted around the opening and closing body 320 of the fluid flow interrupter 300, waterproofing is ensured in a reliable manner.

As a consequence, since the service water introduced into the head 100 through the inlet port 110 is prevented from flowing into the filter body 200, even though a separate fluid flow interruption valve is not installed, fluid flow can be effectively interrupted, whereby it is possible to conveniently clean the inside of the filter A or substitute the filtering element arranged in the filter A.

The filter A for a water purifier, according to the present invention, which is provided with the fluid flow interrupter, can be used in a state in which the clip element 520 of the bracket 500 fastened to the wall is fitted into the fitting groove 140 defined in the head 100, whereby the filter A can be firmly installed in the water purifier.

### INDUSTRIAL APPLICABILITY

As is apparent from the above description, the present invention provides advantages in that since the fluid flow interruption means is disposed in a filter for a water purifier, it is possible to interrupt fluid flow even without installing a separate water flow interruption valve, whereby an outer appearance of the water purifier can be improved and user convenience can be ensured.

I claim:

1. A filter for a water purifier, said water purifier being comprised of a head defined by a guide passage for fluid introduced into said head through an inlet port, an outlet port discharging purified fluid to an outside thereof, and a filter body threadedly locked to said head and said guide passage into which the fluid flows through, said guide passage being in communication with said inlet port of said head, the fluid flowing therein, purified fluid being transferred to said outlet port of said head, said filter comprising:
fluid flow interruption means comprising an elastic spring;
a fluid flow interrupter disposed in said guide passage in communication with said inlet port, having a fluid guide rod formed at one end of said fluid flow interrupter and an opening and closing body connected at one end thereof to a fluid guide rod, said opening and closing body having a diameter gradually decreasing in a downward direction around which an O-ring is fitted and forming an opening and closing projection from another end thereof, said fluid flow interrupter controllably engaging opening and closing said guide passage by force of said elastic spring, said head and filter body being coupled to and un-coupled from each other; and
at least one through-hole on an upper end of said filter body, fluid having passed through said guide passage in communication with said inlet port flowing through said through-hole into said filter body,
wherein said guide passage has a hollow cylindrical protuberance formed at another end thereof, said hollow cylindrical protuberance having an inner diameter greater than an outer diameter of said fluid guide rod of said fluid flow interrupter, said other end of said guide passage having an inner diameter gradually decreasing in a downward direction, said elastic spring having one end through which said fluid guide rod of said fluid flow interrupter is inserted and another end being fitted around said hollow cylindrical protuberance.

2. The filter set forth in claim 1, further comprising:
a bracket having one end coupled to an outer surface of said head and another end fastened to a wall.
